(19) United States
(12) Patent Application Publication
(10) Pub. No.: US 2009/0015418 A1
(43) Pub. Date: Jan. 15, 2009

(54) ELECTRONIC DEVICE, MANAGEMENT METHOD AND COMPUTER-READABLE RECORDING MEDIUM WHICH STORES MANAGEMENT PROGRAM

(75) Inventor: Nobuyuki KOIKE, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited

(21) Appl. No.: 12/238,702

(22) Filed: Sep. 26, 2008

Related U.S. Application Data
(63) Continuation of application No. PCT/JP2006/306736, filed on Mar. 30, 2006.

(51) Int. Cl. G08B 21/00

(52) U.S. Cl. 340/636.1; 340/540

(57) ABSTRACT

There is provided an electronic device having a detachable part and a main unit with a communicating section. In order to prevent the electronic device from being left, the electronic device including a sensor detecting a detached state of the part; a first timer measuring time for which the part has been in a detached state from the main unit since the sensor has detected the detached state of the part; and a warning section issues a warning, the warning section issues the warning if the first timer detects the passage of a first time period.

### TECHNICAL FIELD

The present invention relates to a technique of use of an electronic device such as a USB memory being connected to an information terminal.

### BACKGROUND OF THE INVENTION

In the recent years, there have been widely used portable data storage devices, represented by USB (Universal Serial Bus) memories, each including a set of connection terminals (USB connector) for the connection to computers and a memory capable of retaining data.

Users carry such USB memories, and connect USB memories to computers at destinations (while being out) by inserting the connector (USB connector) of the USB memory into a USB port of the computer. Then the users access to the memory section in the USB memory device from the computer for data reading, storing, and deleting with respect to the memory in the USB memory device.

[Patent Reference] Japanese Unexamined Patent Application (Translation of PCT Application) No. 2004-519791

### DISCLOSURE OF THE INVENTION

### Problems to be Solved by Invention

However, after a user uses such a conventional USB memory by connecting the memory to a computer while being out, for example, the USB memory may be left inserted to a USB port of the computer so that the user forgets to take the USB memory. Leaving a USB memory and the resultant loss of the USB memory loses the data stored in the memory and further, if the USB memory retains important confidential data, there is a possibility to divulge the confidential data.

As an example to improve confidentiality of data being stored in −USB memories, the above Patent Reference 1 discloses a USB memory comprising a verification module with a fingerprint sensor and a nonvolatile memory. In Patent Reference 1, the fingerprint sensor scans the fingerprint of a person, and if the scanned fingerprint corresponds to fingerprint data previously registered, the person is allowed to access the nonvolatile memory. If the scanned fingerprint data does not correspond to the fingerprint data, the access to the nonvolatile memory is not permitted so that confidentiality is ensured.

However, the USB memory of the Patent Reference 1 cannot prevent the user from leaving the USB memory, and incorporation of a verification module into the USB memory increases the production cost of the USB memory.

With the foregoing problems in view, the object of the present invention is to prevent an electronic device from being left.

### Means to Solve the Problem

To attain the above object, here is provided an electronic device including a communicating section communicably connecting the electronic device to an information processor, the electronic device comprising: a main unit detachably coupled to a part and including the communicating section; a sensor detecting a detached state of the part; a first timer measuring elapsed time since the detection of detachment; and a warning section warning a user of the electronic device, the warning section warning the user if the first timer detects the expiration of a first time period.

The electronic device may further comprise: a connection detecting section detecting establishment of connection of the main unit to the information processor via the communicating section; and a second timer measuring elapsed time since the detection of establishment of the connection, and the warning section may warn the user if the second timer detects expiration of a second time period.

Additionally, the electronic device may further comprise: a chargeable battery supplying electricity to the warning section; and a battery remaining amount measuring section measuring the remaining amount of the battery, and the warning section may warn the user if the battery remaining amount measuring unit detects that the remaining amount of the battery is a predetermined amount or less.

Further, the chargeable battery may be incorporated in the main unit and may be charged with electricity supplied from the information processor via the communicating section while the communicating section connects the main unit to the information processor.

Still further, the chargeable battery may be incorporated in the part and may be charged with electricity supplied from the main unit.

Still further, the chargeable battery may be further incorporated in the main unit; the second chargeable battery incorporated in the main unit may be electrically connected to the first battery incorporated in the parts while the part is attached to the main unit; and the first battery incorporated in the part may be charged with electricity supplied by the second battery incorporated in the main unit while the part is attached to the main unit.

Still further, the electronic device may further comprise a memory being able to retain data.

Still further, the part may be in the form of a cap detachably attached to the communicating section.

The communicating section may be in the form of a connection terminal electrically connected to the information processor.

Still further, the electronic device is preferably a portable memory device.

The electronic device may be a USB (Universal Serial Bus) device connected to the information terminal via a USB.

Additionally, here is provided a management method preventing an electronic device comprising a communicating section communicably connecting the electronic device to an information processor from being left, comprising the steps of: (a) detecting a detached state of a part configured to be detachably attached to a main unit of the electronic device; (b) measuring elapsed time since the detection of detachment in the step (a) of detecting; and (c) warning, if the step (b) of measuring detects the expiration of a first time period.

Further, the management method may further comprise the steps of: (d) measuring elapsed time since a communicating section provided in the electronic device to which the part is detachably attached is connected to the information processor; and (e) warning if the step (d) detects expiration of a second time period.

The management program of the present invention instructs electronic devices to execute the steps of the above management method, and the computer-readable recording medium of the present invention stores the management program.

### EFFECTS OF INVENTION

The present invention guarantees at least one of the effects and advantages below.

(1) The user can recognize that the electronic device is currently being used and can avoid leaving the electronic device;

(2) The user can grasp a low battery state, and can thereby avoid an eventuality caused by the low battery state;

(3) The reliability of the electronic device can be improved;

(4) Chargeability of the battery is highly convenient;

(5) The reliability can be improved;

(6) Confidentiality of data can be improved, preventing the confidential data from divulging;

(7) It is possible to prevent the user from being annoyed by the warnings; and

(8) It is possible to prevent a third person from invalidly using the data in the electronic device or in the information processor.

### BRIEF DESCRIPTION OF THE DRAWINGS

FIG. 1 is a diagram schematically showing the functional configuration of the USB (Universal Serial Bus) memory according to a first embodiment of the present invention;

FIG. 2 is a diagram schematically showing a hardware configuration of the main unit of the USB memory of the first embodiment;

FIG. 3 is a diagram schematically showing a hardware configuration of a PC (Personal Computer) to which the USB memory of the first embodiment is to be connected to;

FIG. 4 is a flow diagram showing procedural steps for detaching the cap of the USB memory of the first embodiment;

FIG. 5 is a flow diagram showing procedural steps for connecting the USB memory of the first embodiment to the PC;

FIG. 6 is a diagram showing a functional configuration of the USB memory according to a first modification to the first embodiment;

FIG. 7 is a diagram showing a functional configuration of the USB memory according to a second modification to the first embodiment;

FIG. 8 is a diagram schematically showing the functional configuration of the USB (Universal Serial Bus) memory according to a second embodiment;

FIG. 9 is a flow diagram showing procedural steps for detaching the cap of the USB memory of the second embodiment;

FIG. 10 is a flow diagram showing procedural steps for connecting the USB memory of the second embodiment to the PC;

FIG. 11 is a diagram schematically showing the functional configurations of the USB memory and a PC according to a third embodiment;

FIG. 12 is a diagram schematically showing the functional configuration of the USB memory according to a fourth embodiment;

FIG. 13 is a diagram schematically showing the functional configuration of a USB memory according to a fifth embodiment and a PC used by connecting to the USB memory; and

FIG. 14 is a diagram schematically showing the functional configuration of a USB memory according to a sixth embodiment and a PC to connect to the USB memory.

### EXPLANATION OF SYMBOLS

1a, 1b, 1c, 1d, 1e, 1f, 1g, 1h USB memory (electronic device)
10a, 10b, 10c, 10d, 10e, 10f, 10g, 10h main unit
11 memory section
12, 45 connection detecting section
13, 13-1, 13-2 first timer (timer)
14 second timer
15, 15-1, 15-2, 37 warning section
16, 16-1, 16-2 switch (sensor)
17 USB connector (communicating section, connection terminal)
18, 18-1, 18-2 battery remaining amount measuring section
19, 19-1, 19-2 battery
20a, 20b, 20c, 20d, 20f cap (part)
30a, 30e, 30g, 30h PC (information processor, computer)
32 connection retaining section
33 warning controller
34 unused state detecting section
35 user detecting section
36 timer
38 user confirming section
39 user information obtaining section
40 USB memory confirming section
41 duplication prohibiting section
42 access prohibiting section
43 passing time measuring section
44 retaining time limit setting section
46 managing section
101 computer
102 processor
103 RAM
104 control software ROM
105 timer
106 USB interface
107 flash memory interface
108 buzzer circuit
109 cap detecting switch
110 flash memory
112 power supply circuit
113 charging circuit
191 electrodes
201 attachment inlet
301 CPU
302 ROM
303 RAM
304 display
305 HDD (memory)
306 keyboard
307 mouse
308 USB controller

### BEST MODE FOR CARRYING OUT THE INVENTION

Hereinafter, embodiments of the present invention will now be described with reference to the accompanying drawings.

### (A) First Embodiment

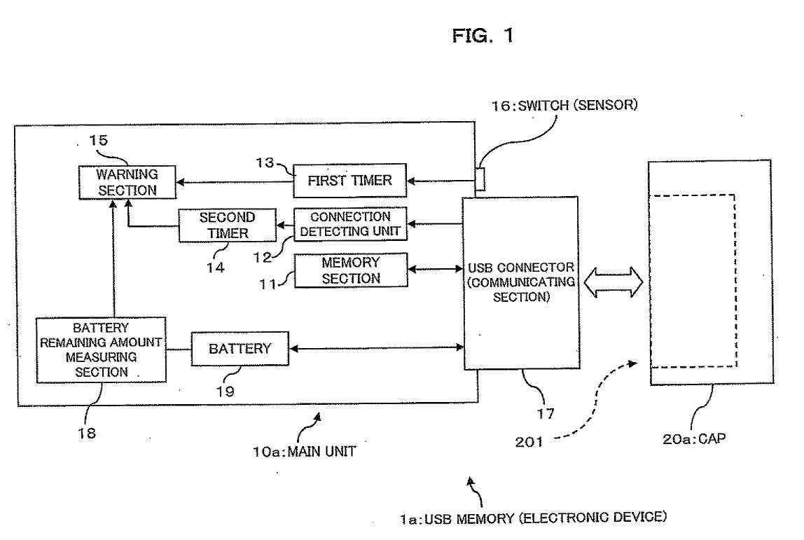

FIG. 1 is a diagram schematically showing a functional configuration of a USB (Universal Serial Bus) memory according to a first embodiment of the present invention.

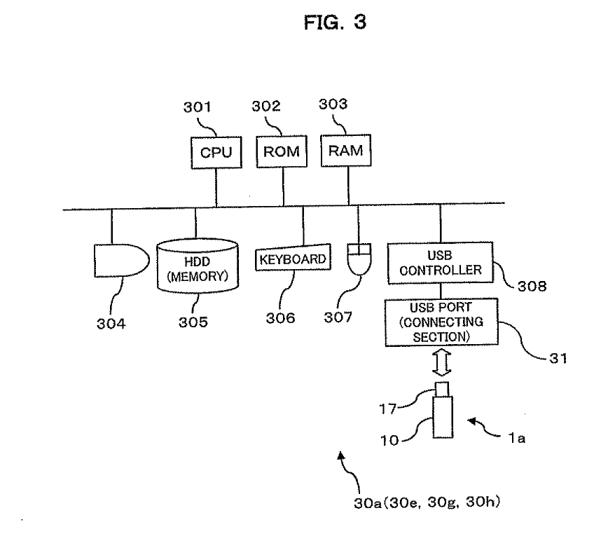

The USB memory (an electronic device) 1a of the first embodiment comprises, as shown in FIG. 1, the main unit 10a including a USB connector (a communicating section, a connection terminal) 17 and a memory section 11, and a cap (a part) 20a configured to be detachably attached to the USB connector 17. When the USB connector 17 is inserted and connected to a USB port 31 of a PC (a Personal Computer; an information processor, a computer) 30a (see FIG. 3) that is to be detailed below, the USB memory 1a is communicably connected to the PC 30a, which then accesses the memory section 11 to write, read, or delete data or files (hereinafter simply called “data”). The USB memory 1a is a portable memory device.

The main unit 10a of the USB memory 1a includes a memory section 11, a connection detecting section 12, a first timer 13, a second timer 14, a warning section 15, a switch 16, a USB connector 17, a battery remaining amount measuring section 18, and a battery 19, as shown in FIG. 1.

The Memory section 11 readably retains various data, the USB connector 17 is a connector (a male connector) formed in accordance with the Universal Serial Bus Standard and is configured to be connectably inserted into various electronic devices (e.g., the PC 30a in the first embodiment) equipped with USB ports 31 (USB connectors (female connectors), see FIG. 3) conforming to the same USB Standard.

Connection detecting section 12 detects that main unit 10a of the USB memory 1a establishes connection to the PC 30a via on of the USB connectors 17. The connection to the PC 30a is detected by the connection detecting section 12 in various publicly known methods. Upon detecting establishment of connection of the USB memory 1a to the PC 30a, the connection detecting section 12 outputs a signal (a connection detecting signal) that notifies the establishment to the second timer 14.

Hereinafter, connection of the main unit 10a of the USB memory 1a to the PC 30a via the USB connector 17 is also simply called connection of the USB memory 1a to the PC 30a.

The Cap 20a is mounted to the USB connector 17 when the USB memory 1a is not in use to protect the USB memory 1a and the USB connector 17 from physical and/or electrical external stimulus and to prevent contamination such as dusts from entering USB connector 17. the Cap 20a is formed of an insulation material exemplified by resin.

The Cap 20a has attachment inlet 201 which is same in shape with the USB connector 17 and is capable to accommodate the USB connector 17. Insertion of the USB connector 17 into the attachment inlet 201 mounts the cap 20a to the USB connector 17. With this configuration, the cap 20a can be detachably attached to the USB connector 17, namely, to the main unit 10a (i.e., the USB memory 1a).

In the USB memory 1a of the first embodiment, when the cap 20a is put on the USB connector 17, the switch 16 is depressed which is adjacent to the USB connector 17 on the main unit 10a by part of the cap 20 and the like.

The switch (sensor) 16 detects a detached state of the cap 20a from the USB connector 17. The switch detects detachment of the cap 20a from the USB connector 17 (i.e. a transition to the detached state) and outputs a signal (detached state detecting signal) that notifies the detachment to first timer 13.

The first timer 13 measures how long the cap 20a is detached since the switch 16 detects the detached state. Specifically, the first timer 13 starts measurement (by countdown) upon receipt of the detached state detecting signal from the switch 16, and at an expiration of a predetermined time period (a first time period), outputs a signal (first time period detection signal) that notifies the expiration to the warning section 15 to be detailed below.

The second timer 14 measures the time for which a connection state of the USB connector 17 to the PC 30a has continued since connection detecting section 12 has detected establishment of the connection. Specifically, the second timer 14 starts measurement (by countdown) upon receipt of a connection detecting signal from the connection detecting section 12, and at an expiration of a predetermined time period (a second time period), outputs a signal (second time period detection signal) that notifies the expiration to the warning section 15 to be detailed below.

The battery 19 supplies electricity to various elements, as well as the warning section 15 to be described below, in the main unit 10a of the USB memory 1a and is in the form of a chargeable battery.

USB ports have bus power (USB bus power) function to prompt a computer to supply electricity to peripheral devices through USB connectors and USB cables. Also in the present embodiment, the PC 30a supplies electricity to the main unit 10a through the USB connector 17 and the USB port 31 while the USB memory 1a (main unit 10a) is being connected to the PC 30a.

The Battery 19 is automatically charged with electricity supplied from the PC 30a through the USB connector 17 and the USB port 31 while the USB memory 1a (the main unit 10a) is being connected to the PC 30a.

The Battery remaining amount measuring section 18 measures the remaining amount of the battery 19. The Battery remaining amount measuring section 18 compares the measured remaining amount of battery 19 with a predetermined amount and, if detecting that the remaining amount is less than the predetermined amount, the battery remaining amount measuring section 18 outputs a signal (a low battery detecting signal) that notifies the low battery to the warning section 15 to be detailed below.

The Warning section 15 warns the user of the USB memory 1a with, for example, stimulus applied to the five senses (vision, hearing, touch, taste, and scent) to arouse attention of the user. This embodiment will be described assuming that the warning section 15 makes a sound (an alarm sound) having a particular frequency to arouse the sense of hearing of the user.

The Warning section 15 warns the user when the first timer 13 detects an expiration of the first time period, and specifically issues a warning upon receipt of a first time period detecting signal from first timer 13.

The Warning section 15 also warns the user when the second timer 14 detects an expiration of second first time period, and specifically issues a warning upon receipt of a second time period detecting signal from the second timer 14.

Further, the warning section 15 warns the user if the remaining amount of the battery 19 is detected to be the predetermined amount or less, and specifically issues a warning upon receipt of a low battery detecting signal from the battery remaining amount measuring section 18.

The USB memory 1a of the first embodiment issues warnings in the form of alarm sounds upon receipt of a first time period detecting signal from the first timer 13, upon receipt of a second time period detecting signal from the second timer 14, and upon detection of the low battery (remaining amount of battery 19 is lower than the predetermined amount). The alarm sounds may be the same, different from one another, or may be partially the same.

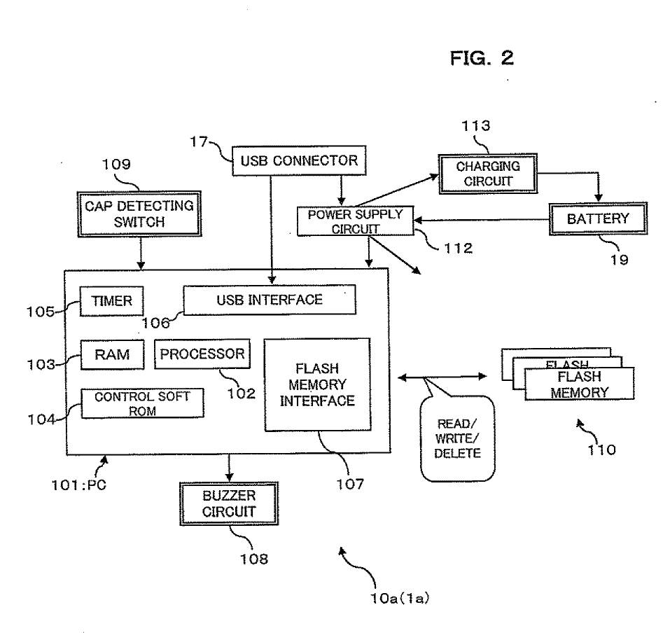

FIG. 2 is a diagram schematically showing the hardware configuration of the main unit 10a of the USB memory 1a of the first embodiment.

Like reference numbers designating similar parts or elements throughout several views of different illustrated examples, so any repetitious description is omitted here.

The Main unit 10a of the USB memory 1a of the first embodiment comprises a computer 101, a buzzer circuit 108, a cap detecting switch 109, a USB connector 17, a power supply circuit 112, a charging circuit 113, a battery 19, and a flash memory 110, as shown in FIG. 2.

The Cap detecting switch 109 takes the form of, for example, a push switch, and is depressed when the USB connector 17 is covered with the cap 20a, and is released by removal of the cap 20a from the USB connector 17. The Cap detecting switch 109 functions as a switch (sensor) 16 in FIG. 1. In addition, the cap detecting switch 109 is not limited to a push switch and can be modified variously without departing the spirit of the present invention.

The Power supply circuit 112 controls to supply elements in the main unit 10a with electricity (bus power) provided through the USB connector 17 and electricity provided by the battery 19. The Power supply circuit 112 measures the remaining amount of the battery 19 and controls the charging circuit 113 to charge the battery 19. Namely, the power supply circuit 112 functions as the battery remaining amount measuring section 18 of FIG. 1.

The Charging circuit 113 charges the battery 19 under control of the power supply circuit 112, and specifically charges the battery 19 with electricity supplied through the USB connector 17.

The Flash memory 110 takes the form of a semiconductor memory free to delete and write data, and keeps to retain data even if the power is turned off. The Flash memory 110 functions as the memory section 11 shown in FIG. 1. Under the control of the flash memory interface 107 in the computer 101, data reading, writing, and deleting are performed on the flash memory 110.

In the example shown in FIG. 2, there is provided a number (three) of flash memories 110, but the number is not limited to three. There may be two or less, or four or more flash memories 110.

The Computer 101 carries out various controls of the USB memory 1a and takes the form of an integrated circuit, which includes a processor 102, RAMs 130, control software ROMs 104, a timer 105, a USB interface 106, and a flash memory interface 107, as shown in FIG. 2.

The Control software ROM 104 retains various programs to realize the functions as the computer 101.

The Processor 102 executes programs stored in the control software ROM 104, and thereby carries out various controls to realize the functions as the computer 101.

The RAM 103 temporarily retains data and programs used when the processor 102 executes the program.

The Timer 105 measures various time periods and takes the form of a counter that functions as the first timer 13 and the second timer 14 shown in FIG. 1.

The USB interface 106 controls communication with the PC 30a through the USB connector 17 and the USB port 31, and detects establishment of connection of the USB memory 1a to the USB port 31 of the PC 30a through the USB connector 17 to function as connection detecting section 12 shown in FIG. 1.

The Flash memory interface 107 controls reading, writing, and deleting data performed on the flash memory 110.

The Buzzer circuit 108 emits alarm sounds having predetermined frequencies under control of the computer 101 and functions as the warning section 15 shown in FIG. 1. the Buzzer circuit 108 can be formed of various known circuits.

The Buzzer circuit 108 may output alarm sounds for a particular time period and then halt the alarm, or may halt the alarm in response to an external input. The alarm sound output may be modified without departing the gist of the present invention.

An external input may be by the user or the like, and may be exemplified by detection that the cap 20a is attached to cover the USB connector 17.

The USB memory 1a of the first embodiment is equipped with a power switch to control supply-on/off (turning on/off the power) of electricity to the elements of the main unit 10a from the battery 19. In the first embodiment, for example, it is preferable that the switch 16 (the cap detecting switch 109) additionally has a function as a power switch and turns on the power upon detection of a detached state of the cap 20a from the USB connector 17.

As a substitute for the switch 16 (the cap detecting switch 109) serving as a power switch, another power switch may be provided.

FIG. 3 is a diagram showing the hardware configuration of the PC 30a to which the USB memory 1a of the first embodiment is to be connected.

As shown in FIG. 3, the PC (the information processor) 30a comprises a CPU 301, a ROM 302, a RAM 303, a display 304, an HDD 305, a keyboard 306, a mouse 307, a USB controller 308, and a USB port (USB connector, connecting section) 31.

The CPU (Central Processing Unit) 301 performs various arithmetic operations by executing programs stored in the HDD 305 and the ROM 302 and performs various controls of the PC 30a.

The ROM (Read Only Memory) 302 stores therein programs and data to be used by the CPU 301, and the RAM (Random Access Memory) 302 temporarily store therein programs and data to be used by the CPU 301.

The Display 304 is a monitor to show various pieces of information, and the HDD (Hard Disk Drive) 305 is a storage unit to store therein and retain various programs and data. The Keyboard 306 and the mouse 307 are input devices with which an operator makes various inputs and selections.

The USB port 31 is a connector (a USB connector, a female connector) configured in accordance with the Universal Serial Bus Standard and can be connected to the USB connectors of various USB devices formed conforming to the USB Standard. The USB connector 17 of the USB memory 1a is detachably inserted and connected to the USB port 31.

USB controllers 308 controls communication with a USB device (USB memory 1a) connected via the USB port 31.

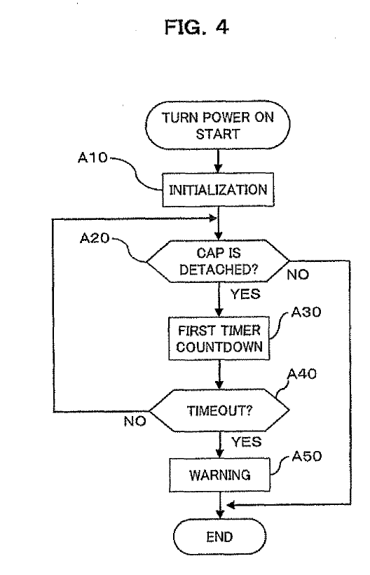

The procedure performed when the cap 20c (of the USB memory 1a of the first embodiment) is to be detached will now be described with reference to a flow diagram (steps A10-A50) shown in FIG. 4.

In the USB memory 1a, when the user detaches the cap 20a from the USB connector 17, the cap detecting switch 109 (switch 16) detects the detachment (the detecting step), and turns on the power of the main unit 10a and initializes the elements in the main unit 10a (step A10).

Further, if the cap detecting switch 109 detects a detached state of the cap 20a (YES route in step A20), the timer 105 (first timer 13) measures (by countdown) how long is it in the detached state (first measuring step, step A30)

Then the timer 105 judges whether or not a first time period that has been predetermined is expired, that is, a timeout occurs (step A40). If the first time period has not passed yet (NO route in step A40), the procedure returns to step A20. On the other hand, if the first time period has passed (YES route in step A40), timer 105 outputs a first time period detecting signal to the buzzer circuit 108 (warning section 15), which in response emits a predetermined alarm sound to warn the user (the first warning step, step ASO), and the procedure terminates.

When the cap detecting switch 109 detects attachment of the cap 20a to the USB connector 17 (the attached state) (No rote in step A20), the procedure terminates.

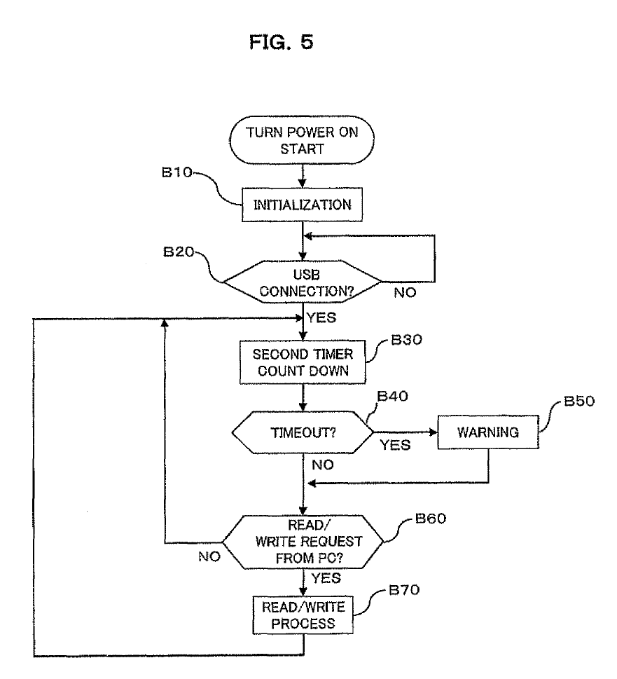

Next, procedural steps for connection between the USB memory 1a of the first embodiment and the PC 30a will now be described with reference to the flow diagram (steps B10-B70) shown in FIG. 5.

In the USB memory 1a, when the user detaches the cap 20a from the USB connector 17, the cap detecting switch 109 detects the detachment, and turns on the power of the main unit 10a and initializes the elements in the main unit 10a (step B10).

The USB interface 106 (connection detecting section 12) detects establishment of connection (USB connection) of the main unit 10a to the USB port 31 of the PC 30a via the USB connector 17 (YES route in step B20), the timer 105 (second timer 14) measures (by countdown) the time for which USB connector 17 has been connected to PC 30a (the second measuring step; step B30.

Then the timer 105 judges whether or not a second time period that has been predetermined expired, that is, a timeout occurs (step B40). If the second time period has not passed (NO route in step B40), the timer 105 waits for a request from the PC 30a to read, write, delete data or the like with respect to the flash memory 110 (memory section 11) (step B60).

When the PC 30a issues an access request (YES route in step B60), the flash memory interface 107 performs a reading/writing process or the like on the flash memory 110 in response to the request (step B70) and the procedure returns to step B30.

If the second time period has passed (YES route in step B40), the timer 105 outputs a second time period detecting signal to the buzzer circuit 108 (warning section 15), which in response emits a predetermined alarm sound to warn the user (the second warning step, step B50), and the procedure moves to step B60.

If the PC 30a issues no access request (No route in step B60), the procedure returns to step B30.

As described above, in the USB memory 1a of the first embodiment, the warning section 15 warns the user of the USB memory 1a upon an expiration of first time period since the cap 20a detached from the USB connector 17, so that the user recognizes that the USB memory 1a is currently being used. For example, that thereby can prevent the USB memory 1a from being left inserted to the PC 30a, or from being left alone.

Further, because the warning section 15 warns the user of the USE memory 1a upon an expiratin of first time period for which the USB memory 1a has established the connection to the PC 30a via the USB connector 17 and the USB port 31, the user recognizes that the USB memory 1a is currently being used so that it is possible to prevent the USE memory 1a from being left inserted to PC 30a, or from being left alone.

In addition, because the warning section 15 warns the user of the USB memory 1a upon detection that the remaining amount of the battery 19 being less than the predetermined amount, the user can recognize such a low remaining amount of battery 19, avoiding a circumstance where elements of the main unit 10a cannot function due to low battery. That can improve the reliability of the USB memory 1a.

While the USB memory 1a is being connected to the PC 30a via the USB connector 17 and the USB port 31, the battery 19 is automatically charged by the USB bus power and resolves the lack of remaining amount of the battery 19 to provide improved reliability of the USB memory 1a and high convenience.

### (B) First Modification of the First Embodiment

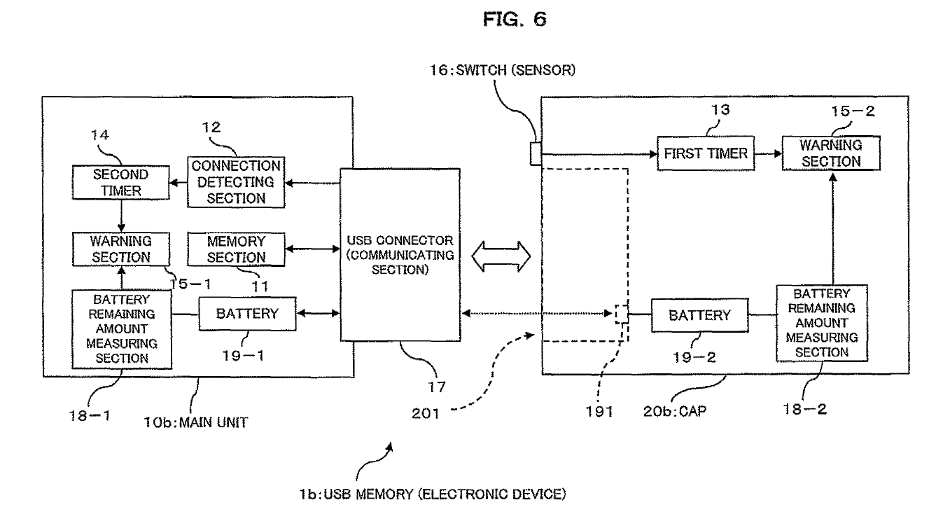

FIG. 6 is a diagram showing the functional configuration of the USB memory 1b according to a first modification of the present invention.

Similarly to the USB memory 1a of the first embodiment, when the USB connector 17 is inserted and connected to the USB port 31 of the PC 30a (see FIG. 3), the USB memory (an electronic device) 1b of the first modification is communicably connected to the PC 30a, which then accesses to the memory section 11 to write, read, and delete data. As shown in FIG. 6, the USE memory 1b comprises a main unit 10b including a USB connector (a communicating section, a connection terminal) 17 and a memory section 11, and a cap (a part) 20b configured to detachably attached to the USB connector 17.

The USB memory 1b of the first modification comprises a main unit 10b including a memory section 11, a connection detecting section 12, a second timer 14, a warning section 15-1, a USB connector 17, a battery remaining amount measuring section 18-1, and a battery 19-1; and a cap 20b including a switch (a sensor) 16, a first timer 13, a warning section 15-2, a battery 19-2, and a battery remaining amount measuring section 18-2, as shown in FIG. 6.

Like reference numbers designating similar parts or elements throughout several views of different illustrated examples, so any repetitious description is omitted here.

The hardware configuration of the main unit 10b of the USB memory 1b of the first modification is the same as that of the main unit 10a of the USE memory 1a except that the element corresponding to the cap detecting switch 109 of FIG. 2 is disposed on the cap 20b. The Cap 20b includes the timer 105, the power supply circuit 112, the charging circuit 113, the battery 19, and the buzzer circuit 108 in addition to the element corresponding to the cap detecting switch 109 of FIG. 2.

The Warning sections 15-1 and 15-2 are the same or substantially same as the warning section 15 included in the USB memory 1a of the first embodiment, and are each realized by the buzzer circuit 108. Similarly to the warning section 15 of the USB memory 1a of the first embodiment, the warning section 15-1 disposed in the main unit 10b warns the user in response to receipt of a second time period detecting signal from the second timer 14 or receipt of a low battery detecting signal from the battery remaining amount measuring section 18-1.

On the other hand, the warning section 15-2 included in the cap 20b warns the user in response to receipt of a first time period detecting signal from the first timer 13 in the same manner as the warning section 15 of the USB memory 1a of the first embodiment.

The Battery remaining amount measuring sections 18-1 and 18-2 are the same or substantially the same as the battery remaining amount measuring section 18 of the USB memory 1a of the first embodiment and are each realized by the power supply circuit 112. The Battery remaining amount measuring section 18-1 measures the remaining amount of the battery 19-1. And if the remaining amount is detected to be the predetermined amount or less, the battery remaining amount measuring section 18-1 outputs a low battery detecting signal to the warning section 15-1. In the meanwhile, the battery remaining amount measuring section 18-2 measures the remaining amount of the battery 19-2. And if the remaining amount is detected to be the predetermined amount or less, the battery remaining amount measuring section 18-2 outputs a low battery detecting signal to the warning section 15-2.

The Batteries 19-1 and 19-2 are the same or the substantially the same as battery 19 of USB memory 1a of the first embodiment. The Battery 19-1 supplies electricity to the elements of the main unit 10b, and the battery 19-2 supplies electricity to the elements included in the cap 20b.

In the USB memory 1b of the first modification, the cap 20b includes electrodes 191 placed at attachment inlet 201 to the USB connector 17. The Electrodes 191 are electrically connected to elements of the cap 20b, that is, the battery 19-2, the power supply circuit 112, and the charging circuit 113. Attachment of the cap 20b to the USB connector 17 of the main unit 10b connects the power supply circuit 112, the charging circuit 113, and the battery 19-1 of the main unit 10b to the power supply circuit 112, the charging circuit 113, and the battery 19-2 of the cap 20b via the electrodes 191.

In other words, the USB memory 1b of the first embodiment is configured to electrically connectable the cap 20b to the battery 19-1 included in the main unit 10b while the cap 20b is being attached to the USB connector 17.

When the cap 20b is attached to the main unit 10b (USB connector 17) to connect the power supply circuit 112 of the main unit 10b to the power supply circuit 112 and the charging circuit 113 included in the cap 20 via the electrodes 191, the battery 19-1 of the main unit 10b supplies electricity to the charging circuit 113 of the cap 20b through the electrodes 191 and the charging circuit 113 then charges the battery 19-2 included in the cap 20b with electricity provided by the battery 19-1.

Specifically, in the USB memory 1b of the first modification, the battery 19-2 in the cap 20b is charged with electricity supplied from the battery 19-1 in the main unit 10b while the cap 20b is being attached to the USB connector 17.

In the USB memory 1b of the first modification with the above configuration, detachment of the cap 20b from the USB connector 17 of the main unit 10b and insertion and connecting the USB connector 17 to the USB port 31 of the PC 30a make it possible to read, write, delete data and others between the memory section 11 and the PC 30a.

At that time, the battery 19-1 of the main unit 10b is charged with electricity supplied by the USB bus power via the USB connector 17.

On the other hand, when the switch (sensor) 16 of the cap 20b detects detachment of the cap 20b from the USB connector 17 (a transition to the detached state) (the detecting step), the switch 16 outputs a detached state detecting signal that notifies the detachment to the first timer 13.

After that, upon receipt of a detached state detecting signal from the switch 16, the first timer 13 starts measurement (by countdown) (the first measuring step), and if a predetermined time period (the first time period) is expire, the first timer 13 issues a first time period detecting signal that notifies the expiration to the warning section 15-2. In response to the first time period detecting signal, the warning section 15-2 issues an alarm sound of a predetermined frequency to warn the user (the first warning step).

The Battery remaining amount measuring section 18-2 measures the remaining amount of the battery 19-2. And if the remaining amount is detected to be the predetermined amount or less, the battery remaining amount measuring section 18-2 outputs a low battery detecting signal to the warning section 15-2.

In the meanwhile, the connection detecting section 12 in the main unit 10b detects establishment of connection of the main unit 10b to the PC 30a via the USB connector 17, and then outputs a signal (a connection detecting signal) that notifies the establishment to the second timer 14.

Upon receipt of the connection detecting signal from the connection detecting section 12, the second timer 14 starts measurement (by countdown) (the second measuring step), and if a predetermined time period (the second time period) has passed, the second timer 14 issues a signal (a second time period detecting signal) that notifies the passage to the warning section 15-1. In response to the second time period detecting signal, the warning section 15-1 issues alarm sound of a predetermined frequency to warn the user (the second warning step).

The Battery remaining amount measuring section 18-1 measures the remaining amount (the battery remaining amount) of the battery 19-1. And if the remaining amount is detected to be the predetermined amount or less, the battery remaining amount measuring section 18-1 outputs a low battery detecting signal to the warning section 15-1 to inform the low battery by warning.

When the user attaches cap 20b to the USB connector 17 of the main unit 10b, the battery 19-2 included in the cap 20b is charged with electricity provided from the battery 19-1.

The USB memory 1b of the first modification to the first embodiment as described above guarantees the same effects as the foregoing first embodiment, and provides high convenience because the battery 19-2 included in the cap 20b is charged with electricity provided from the battery 19-1 included in the main unit 10b while the cap 20b is being fitted to the USB connector 17.

### (C) Second Modification of the First Embodiment

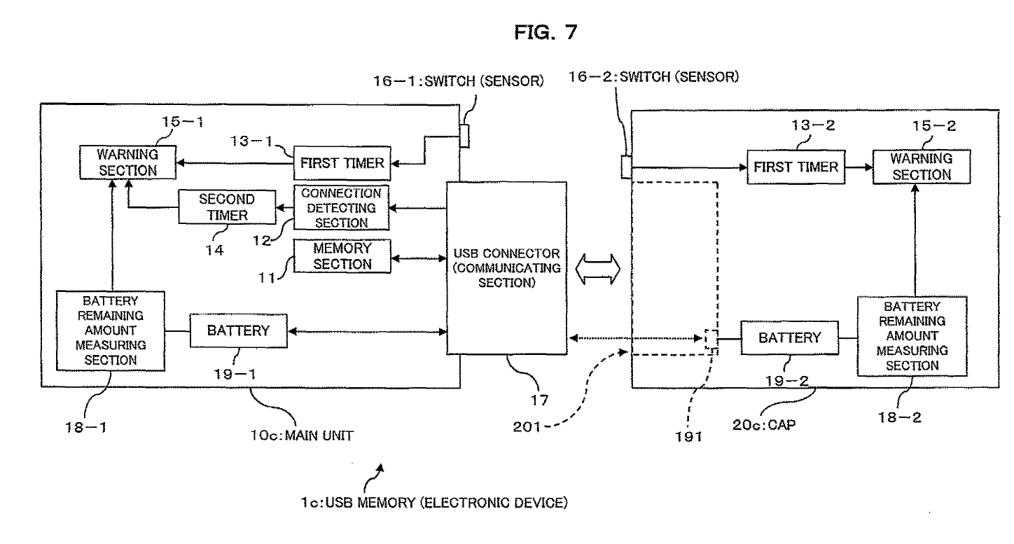

FIG. 7 is a diagram showing the functional configuration of the USB memory 1c according to a second modification of the present invention.

Similarly to the USB memory 1a of the first embodiment, when the USB connector (communicating section, connection terminal) 17 is inserted and connected to the USB port 31 of the PC 30a (see FIG. 3), the USB memory (an electronic device) 1c of the second modification is communicably connected to the PC 30a, which then writes, reads, and deletes data in the memory section 11. As shown in FIG. 7, the USB memory 1c comprises a main unit 10c same in configuration as the main unit 10a of the first embodiment and a cap (a part) 20c, same as the cap 20b of the first modification, configured to detachably attached to the USB connector 17.

Like reference numbers designating similar parts or elements throughout several views of different illustrated examples, so any repetitious description is omitted here.

Switches 16-1 and 16-2 each detect a detached state of the cap 20c from the USB connector 17, are the same or substantially the same as the switch 16 of the first embodiment, and are realized by the cap detecting switch 109.

The First timer 13-1 measures time passed for which the cap 20c has been in the detached state since the detached state of the cap 20c detected by the switch 16-1, and the first timer 13-2 measures time passed for which for which the cap 20c has been in the detached state since the detached state of the cap 20c has been detected by the switch 16-2.

The First timers 13-1 and 13-2 are the same or substantially the same as first timer 13 of the first embodiment.

In the USB memory 1c of the second modification with the above configuration, when the cap 20c is detached from the USB connector 17 of the main unite 10c and the USB connector 17 is inserted and connected to the USB port 31 of the PC 30a, processes such as data reading, writing and deleting is carried out between the memory section 11 and the PC 30a.

At this time, the battery 19-1 of the main unit 10c is charged with electricity supplied by the USB bus power through the USB connector 17.

When the switch (sensor) 16-2 of the cap 20c detects detachment of the cap 20c from the USB connector 17 (a transition to the detached state) (the detecting step), the switch 16-2 outputs a signal (a detached state detecting signal) that notifies the detection to the first timer 13-2.

Then, upon receipt of the detached state detecting signal from the switch 16-2, the first timer 13-2 starts measurement (by countdown) (the first measuring step), and after a predetermined time period (the first time period), first timer 13 issues a signal (a first time period detecting signal) that notifies the passage to the warning section 15-2. In response to receipt of the first time period detecting signal, the warning section 15-2 issues an alarm sound of a predetermined frequency to warn the user (the first warning step).

The Battery remaining amount measuring section 18-2 measures the remaining amount (the battery remaining amount) of the battery 19-2. And if the remaining amount is detected to be the predetermined amount or less, the battery remaining amount measuring section 18-2 outputs a low battery detecting signal to the warning section 15-2, which informs the low battery by the warning.

In the meanwhile, when the switch (sensor) 16-1 of the cap 20c detects its detachment from the USB connector 17 (a transition to the detached state) (the detecting step), the switch 16-1 outputs a signal (a detached state detecting signal) that notifies the detachment to the first timer 13-1.

Upon receipt of the detached state detecting the signal from the switch 16-1, the first timer 13-1 starts measurement (by countdown) (the first measuring step), and if a predetermined time period (the first time period) is expired, the first timer 13-1 issues a signal (a first time period detecting signal) that notifies the expiration to the warning section 15-1. In response to receipt of the first time period detecting signal, the warning section 15-1 issues alarm sound of a predetermined frequency to warn the user (the first warning step).

If it detects an establishment of connection of the main unit 10c to the PC 30a via the USB connector 17, the connection detecting section 12 in the main unit 10b outputs a signal (a connection detecting signal) that notifies the establishment to the second timer 14.

Upon receipt of the connection detecting signal from the connection detecting section 12, the second timer 14 starts measurement (by countdown) (the second measuring step), and if a predetermined time period (the second time period) is expired, the second timer 14 issues a signal (a second time period detecting signal) that notifies the expiration to the warning section 15-1. In response to receipt of the second time period detecting signal, the warning section 15-1 issues an alarm sound of a predetermined frequency to warn the user (the second warning step).

The Battery remaining amount measuring section 18-1 measures the remaining amount of battery 19-1. And if the remaining amount is detected to be the predetermined amount or less, battery remaining amount measuring section 18-1 outputs a low battery detecting signal to warning section 15-1 to inform the low battery by warning.

When the user attaches the cap 20c to the USB connector 17 of the main unit 10c, the battery 19-2 included in the cap 20c is charged with electricity provided from the battery 19-1 included in main unit 10c.

The USB memory 1c of the second modification to the first embodiment as described above guarantees the same effects as the foregoing first embodiment, and an alarm issued by the warning section 15-2 placed also on the cap 20c makes it possible to surely warn the user, improving the reliability of the USB memory 1c.

### (D) Second Embodiment

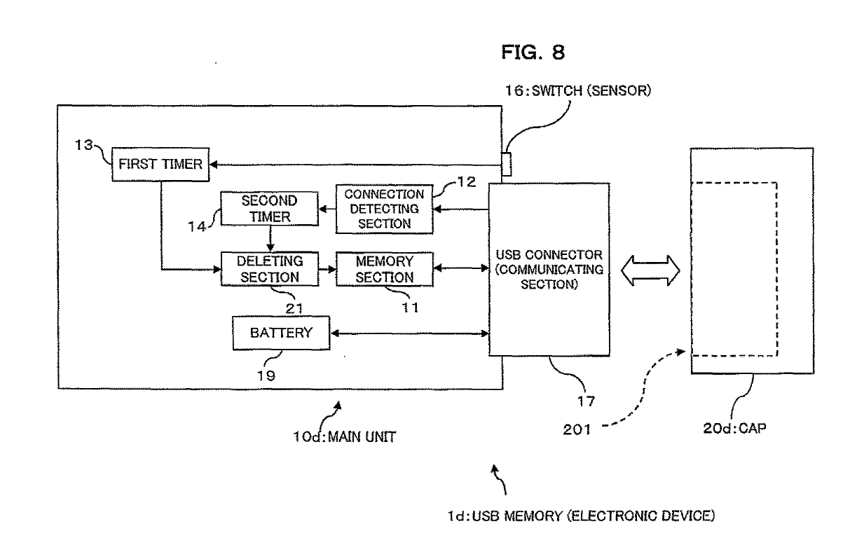

FIG. 8 is a diagram schematically showing the functional configuration of a USB (Universal Serial Bus) memory according to the second embodiment.

Similarly to the USB memory 1a of the first embodiment, when a USB connector (a communicating section, a connection terminal) 17 is inserted and connected to a USB port 31 of a PC 30a (see FIG. 3), the USB memory (an electronic device) 1d of the second embodiment is communicably connected to the PC 30a, which then accesses the memory section 11 to write, read, and delete data. As shown in FIG. 8, the USB memory 1d comprises a main unit 10d including a USB connector 17 and a memory section 11, and a cap (part) 20d configured to be detachably attached to the USB connector 17.

As shown in FIG. 8, the USB memory 1d of the second embodiment comprises a deleting section 21 as a substitute for the warning section 15 and the battery remaining amount measuring section 18 included in the USB memory 1a of the first embodiment, and the remaining is identical to that of the USB memory 1a of the first embodiment.

The Deleting section 21 deletes (erases) the data stored in the memory section 11, and specifically deletes data stored in the memory section 11 when the first timer 13 detects an expiration of a third time period predetermined.

The Deleting section 21 further deletes the data stored in the memory section 11 when the second timer 14 detects an expiration of a fourth time period predetermined.

The Deleting section 21 is, for example, realized by an element corresponding to the flash memory interface 107 shown in FIG. 2. The Deleting section 21 may delete the entire data stored in the flash memory 110 (memory section 11) or may delete a particular data piece. Deletion of a particular data piece can be realized by flagging a data piece that is to be deleted or not to be deleted, or by setting a data piece desired not to be deleted to be disabled for deletion by means of the data protection function possessed by the OS (Operating System) of the computer or the like.

The Battery 19 is automatically charged with electricity supplied from the PC 30a through the USB connector 17 and the USB port 31 while the USB memory 1d (main unit 10d) is connected to the PC 30a.

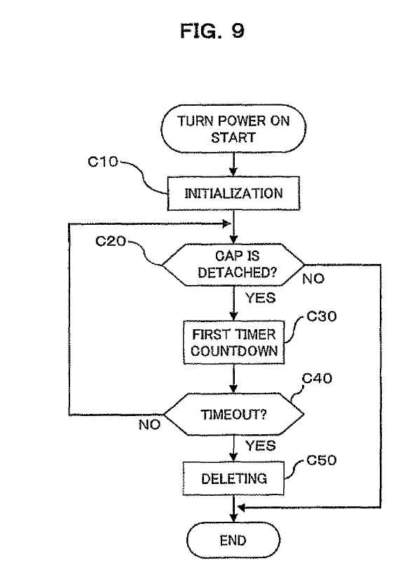

The procedure performed when the cap 20d is detached in the USB memory 1d of the second embodiment will now be described with reference to the flow diagram (steps C10-C50) shown in FIG. 9.

In the USE memory 1d, when the user detaches the cap 20d from the USB connector 17, the cap detecting switch 109 (switch 16) detects the detachment (the detecting step), and turns on the power of the main unit 10d and initializes elements in the main unit 10d (step C10).

If the cap detecting switch 109 detects a detached state of the cap 20d (YES route in the step C20), the timer 105 (first timer 13) measures (by countdown) the time for which 20d has been in the detached state (the first measuring step, step C30).

Then the timer 105 (first timer 13) judges whether or not the third time period that has been predetermined has passed, that is, a timeout occurs (step C40) If the third time period has not passed (NO route in step C40), the procedure returns to step C20. On the other hand, if the third time period has passed (YES route in step C40), the timer 105 outputs a timeout signal to the flash memory interface 107 (deleting section 21), which in response deletes the data stored in the flash memory 110 (memory section 11) (the first deleting step; step C50), and the procedure terminates.

When the cap detecting switch 109 detects attachment of the cap 20d to the USB connector 17 (the attached state) (No rote in step C20), the procedure terminates.

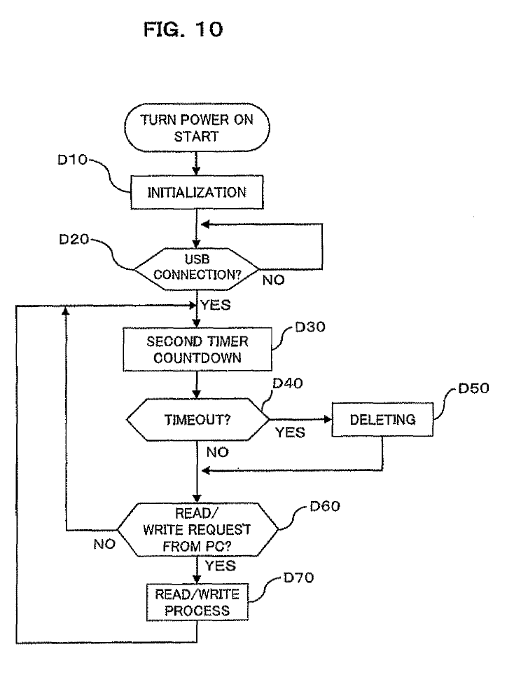

Next, procedural steps for the connection between the USB memory 1d of the second embodiment and the PC 30a will now be described with reference to the flow diagram (steps D10-D70) shown in FIG. 10.

In the USB memory 1d, when the user detaches the cap 20d from the USB connector 17, the cap detecting switch 109 (switch 16) detects the detachment, and turns on the power of the main unit 10d and initializes elements in the main unit 10d (step D10).

When the USB interface 106 (connection detecting section 12) detects establishment of connection (USB connection) of the main unit 10d to the USB port 31 of the PC 30a via the USB connector 17 (YES route in step D20), the timer 105 (second timer 14) measures (by countdown) the time for which the USB connector 17 has been connected to the PC 30a (the second measuring step; step D30).

Then the timer 105 judges whether or not a fourth time period that has been predetermined has passed, that is, a timeout occurs (step D40). If the fourth time period has not passed (NO route in step D40), the timer 105 waits for a request from the PC 30a to read, write, delete data or the like with respect to the flash memory 110 (memory section 11) (step D60).

When the PC 30a issues an access request (YES route in step D60), the flash memory interface 107 performs a reading/writing process or the like on the flash memory 110 in response to the request (step D70) and the procedure returns to step D30.

If the fourth time period has passed (YES route in step D40), the timer 105 outputs a fourth time period detecting signal to the flash memory interface 107 (deleting section 21), which in response deletes the data stored in the flash memory 110 (the second deleting step, step D50), and the procedure moves to step D60.

If the PC 30a issues no access request (No route in step D60), the procedure returns to step D30.

As described above, in the USB memory 1d of the second embodiment, since the passage of the third time period since the cap 20d has been detached from the USB connector 17 causes the deleting section 21 to delete the data stored in the memory section 11, a third person cannot use the data stored in the memory section 11 of the USB memory 1d even if the USB memory 1d is left inserted into the PC 30a and the third person obtains the USB memory 1d left inserted into the PC 30a. That enhances confidentiality of the data, and data divulgation can be prevented.

The Battery 19 is automatically charged with electricity by the USB bus power while the USB memory 1d is connected to the PC 30d via the USB connector 17 and the USB port 31. That enhances convenience of the USB memory 1d by reducing the low battery state of battery 19.

In addition, upon an expiration of the fourth time period, the deleting section 21 also deletes the data stored in the memory section 11 so that confidentiality of the data can be enhanced and data divulgation can be prevented.

### (E) Third Embodiment

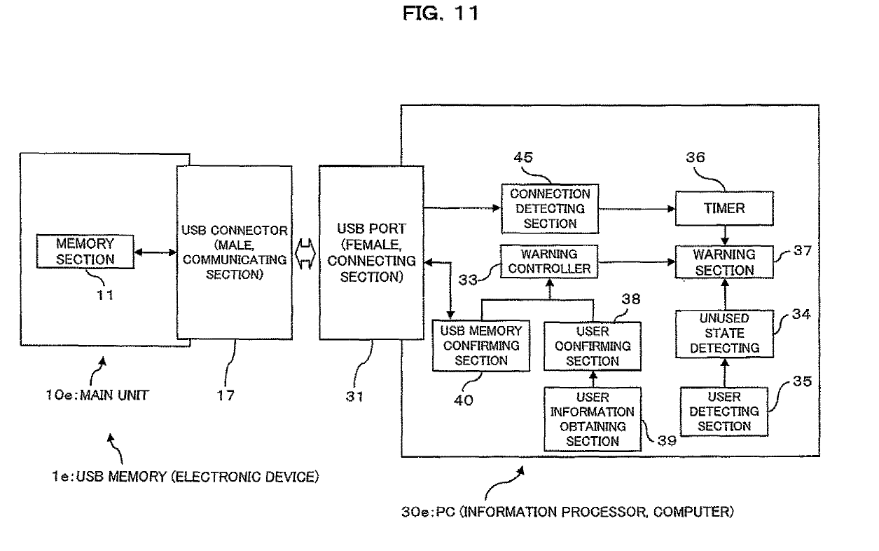

FIG. 11 is a diagram schematically showing the functional configurations of a PC (an information processor, a computer) 30e and a USB (Universal Serial Bus) memory 1e according to the third embodiment of the present invention.

Like reference numbers designating similar parts or elements throughout several views of different illustrated examples, so any repetitious description is omitted here.

The PC 30e of the third embodiment comprises a USB port (USB connector ((female); a connecting section) 31 to which a USB memory 1d is communicably connected. Inserting the USB connector (communicating section, connection terminal) 17 of the USB memory 1e into the USB port 31 communicably connects the PC 30e to the USB memory 1e, so that the PC 30e reads, writes, and deletes data or performs other processes with respect to the memory section 11.

The PC 30e of the third embodiment has the hardware configuration shown in FIG. 3, similarly to the PC 30a of the first embodiment, so any repetitious description is omitted here.

The USB memory 1e comprises, as shown in FIG. 11, the main unit 11e including a USB connector (communicating section, connection terminal) 17 and a memory section 11, and a cap (part, not shown) which is the same in configuration as the cap 20a of the USB memory 1a of the first embodiment and which is detachably attached to the USB connector 17.

As shown in FIG. 11, the PC 30e comprises a USB port 31, a connection detecting section 45, a warning controller 33, an unused state detecting section 34, a user detecting section 35, a timer 36, a warning section 37, a user confirming section 38, a user information obtaining section 39, and a USB memory confirming section 40.

The Connection detecting section 45 detects establishment of connection of the USB memory 1e to the USB port 31, and is, for example, realized by a USB interface or the like similarly to the connection detecting section 12 in the USB memory 1a of the first embodiment. The detection of connection establishment to the USB memory 1e can be detected by any known method.

Upon detecting establishment of a connection of the USB memory 1e to the PC 30e, the connection detecting section 45 outputs a signal (a connection detecting signal) that notifies the establishment to the timer 36.

The Timer 36 measures how long connection state of the USB memory 1e has continued since the connection detecting section 45 has detected establishment of the connection, and similarly to the second timer 14 of the USB memory 1a of the first embodiment, is realized by the timer 105 (see FIG. 2) serving as a counter, for example.

When a predetermined time period (second time period) has passed, the timer 36 outputs a signal (second time period detecting signal) for notification of the expiration to the warning section 37 that is to be detailed below.

The User confirming section 38 confirms that the person (the user) currently using and operating the PC 30e is a particular authorized person of the 30e. In the third embodiment, on the basis of the information (user information) about the user of the PC 30e obtained by the user information obtaining section 39, a confirmation is made as to whether the user of the PC 30e is a particular authorized person of the PC 30e.

particular authorized persons of the PC 30e represents persons with a validity to use the PC 30e exemplified by the owner of the PC 30e, and persons authorized to use the PC 30e by the owner. The information (particular authorized person information; the part not shown) about each particular authorized person is registered in the HDD 305 or the like beforehand. Namely, persons previously registered in the particular authorized person information can be regarded as particular authorized persons.

The User information obtaining section 39 obtains information about the user of the PC 30e, and specifically obtains a set of information (e.g., a password, a fingerprint image, a user face image, information about a smart card or a FeliCa card) that is to be used for confirmation to be made by the user confirming section 38 that the user of the PC 30e is a particular authorized person.

For example, if the user confirming section 38 confirms the user by password verification, an input device such as keyboard 306 used to input a password functions as the user information obtaining section 39. In this example, the user confirming section 38 instructs the user to input the password with the keyboard 306 or the like, and if the input password matches with on of the registered passwords (particular authorized person information) registered in advance, the user confirming section 38 that the user of the PC 30e is a particular authorized person.

Further, if the user confirming section 38 carries out face verification, a camera to input an image of the user face functions as the user information obtaining section 39. In such a case, the user confirming section 38 photographs the user face or the like with a camera, and compares the photo image with the verification data (image data or characteristic data; particular authorized person information) previously registered.

Still further, if the user confirming section 38 carries out fingerprint verification, a fingerprint sensor used to input a fingerprint functions as the user information obtaining section 39. In this case, the user confirming section 38 instructs the user to input a fingerprint via a fingerprint sensor, and compares the fingerprint with the registered fingerprint data (particular authorized person information) previously registered.

If a user is verified by reading information in a smart card or a FeliCa card owned by the user with a card reader and comparing the read information with the registered information (particular authorized person information) previously registered, the card reader to read information in a card functions as user information obtaining section 39.

The manner to confirm by the user confirming section 38 whether or not the user is a particular authorized person is not limited to those described above, and may be accomplished by any of various known verification techniques. A device or the like to obtain required information for the verification corresponds to the user information obtaining section 39.

If the user confirming section 38 judges the user of the PC 30e is a particular authorized person of the PC 30e, the user confirming section 38 outputs a signal (a particular authorized person detection signal) that notifies the confirmation result to the warning controller 33 that is to be described later.

The USB memory confirming section 40 confirms whether or not the USB memory 1e being connected to the PC 30e is related to the particular authorized person.

The USB memory 1e related to the particular authorized person represents the USB memory 1e that is used by a particular authorized person of the PC 30e.

Confirmation of the relation of the USB memory 1e to a particular authorized person is made by the first registration in which the management information representing that the USB memory 1e is owned by the particular authorized person in a management list is stored in the HDD 305 of the PC 30e or the like and the same management information is stored in the memory section 11 of the USE memory 1e.

Then installation of the USB memory 1e to the USB port 31 of the PC 30e prompts the USB memory confirming section 40 to read the management information stored in the memory section 11 of the USB memory 1e and collate the read management with the management information in the management list registered in the PC 30e. In other words, the USB memory 1e having the management information that has been registered in the PC 30e in advance can be called the USB memory 1e related to the particular authorized person.

If the USB memory confirming section 40 confirms that the USB memory 1e being connected to the PC 30e is related to the particular authorized person, the USB memory confirming section 40 outputs a signal (a USB memory confirming signal) that notifies the confirmation result to the warning controller 33.

The User detecting section 35 detects the presence of the user at the PC 30e and detects the presence of the user operating the PC 30e with, for example, various sensors.

If the user detecting section 35 detects the presence of the user operating the PC 30e, the user detecting section 35 outputs a signal (a user detection signal) notifies the presence to the unused state detecting section 34.

The Unused state detecting section 34 detects a transition to any unused state by the user of the PC 30e, and, upon detection of any transition to an unused state, outputs a signal (unused state detecting signal) that notifies the transition to the warning controller 33.

The Unused state detecting section 34 detects any transition to an unused state of the PC 30e when at least one of (1) detection of turning the power of the PC 30e off; (2) detection of transitions of the PC 30e to a power saving mode; and (3) detection of no presence of the user which has been detected by the user detecting section 35.

Detection of a turning the power of the PC 30e off and detection of a transition of the PC 30e to a power saving mode can be realized by various known methods.

In addition, the manner of detection of a transition of the PC 30e to an unused state by the unused state detecting section 34 is not limited to the above manner and various modifications can be suggested.

For example, if there is no activity on the keyboard 306 or the mouse 307 for a predetermined time, the unused state detecting section 34 may judge the absence of the user from the PC 30e, and in this case, the CPU 301 of the PC 30e functions as the user detecting section 35.

The Warning section 37 issues a warning of the PC 30e is the same or substantially the same in configuration as the warning section 15 of the first embodiment. For example, the warning section 37 is realized by a buzzer circuit.

The Warning section 37 issues a warning when the timer 36 detects an expiration of a predetermined time period (the second time period), and specifically issues the warning in response to receipt of a second time period detecting signal from the timer 36.

The Warning section 37 also issues a warning when the unused state detecting section 34 detects any transition of the PC 30e to an unused state, and specifically issues the warning in response to the receipt of any unused state detecting signal from the unused state detecting section 34.

The Warning controller 33 inhibits warning section 37 from issuing a warning the user specifically if the user of the PC 30e is the particular authorized person related to the USB memory 1e. In detail, upon receipt of a particular authorized person detecting signal from the user confirming section 38, the warning controller 33 inhibits the warning section 37 from issuing a warning even when the timer 36 detects an expiration of the predetermined time period.

If the USB memory confirming section 40 confirms that the USB memory 1e connected to the PC 30e is related to the particular authorized person, in other words, if the warning controller 33 receives a USB memory confirming signal from the USB memory confirming section 40, the warning controller 33 inhibits the warning section 37 from warning despite the detection of an expiration of the predetermined time period by the timer 36.

The PC 30e of the third embodiment with the above-described configuration sets (stores) the management information in the memory section 11 of the USB memory 1e beforehand and additionally registers the management information in the management list of the PC 30e.

Insertion of the USB memory 1e into the USB port 31 of the PC 30e prompts the USB memory confirming section 40 to access the memory section 11 of the USB memory 1e to obtain the management information, and compares the obtained management information with the management list previously stored in the HDD 305 or the like, so that the USB memory confirming section 40 confirms as to whether or not the USB memory 1e being connected to the PC 30e is related to the particular authorized person.

The USB memory confirming section 40 outputs a USB memory confirming signal to the warning controller 33 if the USB memory 1e being connected to the PC 30e is related to the particular authorized person.

Further, the user confirming section 38 confirms whether the user is the particular authorized person of the PC 30e on the basis of the user information obtained by the user information obtaining section 39. If the user confirming section 38 judges the person (a user) using and operating the PC 30e to be the particular authorized person of the PC 30e, the user confirming section 38 outputs a particular authorized person detecting signal to the warning controller 33.

Upon detection of establishment of a connection of the USB memory 1e to the USB port 31 (the connection detecting step), the connection detecting section 45 outputs a signal (connection detecting signal) that notifies the establishment to the timer 36, which in response measures a passage time for which the connection has continued since the connection detecting section 45 has detected establishment of the connection of the USB memory 1e (the measuring step). Then upon an expiration of a predetermined time period (the second time period), the timer 36 outputs a second time period detecting signal to the warning section 37.

The Unused state detecting section 34 detects any transition of the PC 30e to an unused state on the basis of information from the user detecting section 35 or the like (the unused state detecting step), the unused state detecting section 34 outputs an unused state detecting signal to the warning controller 33.

Upon receipt of the second time period detecting signal or the unused state detecting signal, the warning section 37 issues a warning (the warning step). However, if the warning controller 33 receives a USB memory confirming signal or a particular authorized person detecting signal, the warning controller 33 controls and inhibits the warning section 37 from issuing a warning (the warning controlling step).

In the PC 30e of the third embodiment, the warning section 37 issues a warning when the second time period has passed since the connection of the USB memory 1e to the PC 30e has been established via the USB connector 17 and the USB port 31 or when the PC 30e has come to be an unused sate. It is thereby possible for the user to recognize that the USB memory 1e is being used and prevent the USB memory 1e from being left inserted to the PC 30e and from being forgotten.

If the user confirming section 38 judges that the user of the PC 30e is a particular authorized person of the same PC 30e or if the USB memory confirming section 40 judges that the USB memory 1e being connected to the PC 30e is related to a particular authorized person, the warning controller 33 inhibits warning section 37 from issuing a warning. With this configuration, despite an expiration of the second time period since the connection of the USB memory 1e to the PC 30e has been established via the USB connector 17 and the USB port 31 or despite the transition of the PC 30e to an unused state, the warning section 37 issues no warning and that therefore does not annoy the user, providing high convenience.

The User information obtaining section 39, which obtains user informations, makes the user confirming section 38 possible to surely confirm that the user is a particular authorized person of the PC 30e with ease.

### (F) Fourth Embodiment

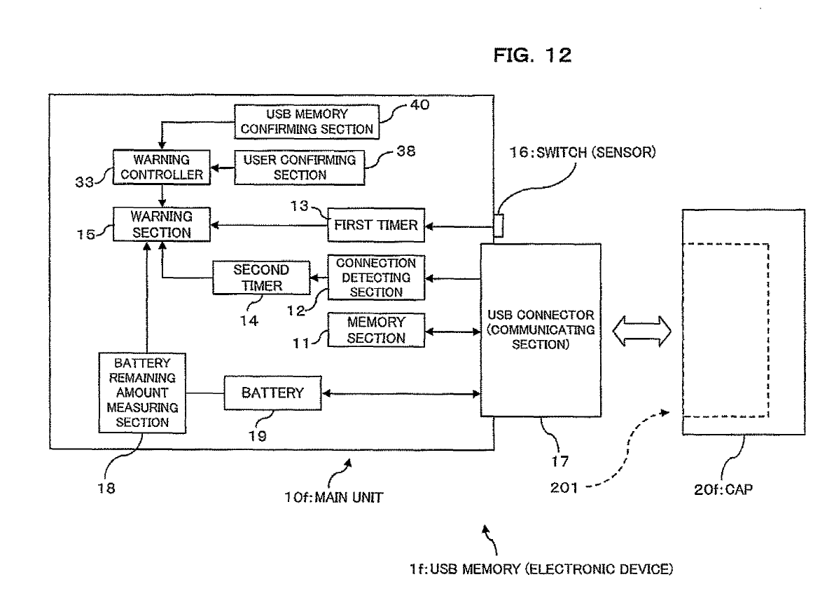

FIG. 12 is a diagram schematically showing the functional configuration of the USB memory if according to the fourth embodiment of the present invention.

The USB memory (an electronic device) If of the fourth embodiment is, similarly to the USB memory 1a of the first embodiment, communicably connected to a PC 30a (see FIG. 3) when a USB connector (a communicating section, a connection terminal) 17 of the USB memory 1f is inserted into a USB port 31 of the PC 30a, so that the PC 30a reads, writes, and deletes data or performs other processes with respect to memory section 11. As shown in FIG. 12, the USB memory if comprises the main unit 10f including the USB connector (communicating section, connection terminal) 17 and the memory section 11, and a cap (a part) 20f detachably attached to the USB connector 17 similarly to the cap 20a of the USB memory 1a of the first embodiment.

As shown in FIG. 12, the USB memory (an electronic device) 1f of the fourth embodiment comprises a warning controller 33, a user confirming section 38, and a USB memory confirming section 40 in addition to the elements of USB memory 1a of the first embodiment, and therefore the remaining part of the memory section if is identical to the elements of the USB memory 1a of the first embodiment.

Like reference numbers designating similar parts or elements throughout several views of different illustrated examples, so any repetitious description is omitted here.

Similarly to the USB memory 1a of the first embodiment, in the USB memory if of the fourth embodiment, warning section 15 warns the user of the USB memory 1f upon passage of the first time period since the cap 20f has been detached form the USB connector 17 or upon passage of the second time period since the connection of the USB memory 1f to the PC 30e has been established via the USB connector 17 and the USB port 31 in the same manner as the first embodiment.

Additionally, in the USB memory if of the fourth embodiment, the user confirming section 38 that confirms the is user is the particular authorized person of the PC 30a, and if the user of the PC 30a is judged to be the particular authorized person of the same PC 30a or if the USB memory confirming section 40 judges that the USB memory if being connected to the PC 30a is related to the particular authorized person, warning controller 33 inhibits the warning section 37 from warning the user in the same manner as the first embodiment.

With this configuration, despite a passage of the second time period since the connection of the USB memory if to the PC 30a has been established via the USB connector 17 and the USB port 31 or despite any transition of the PC 30a to any unused state, the warning section 15 issues no warning and that therefore does not annoy the user, providing high convenience.

Therefore the USB memory 1f of the fourth embodiment can obtain the same effects as both the first and the third embodiments.

### (G) Fifth Embodiment

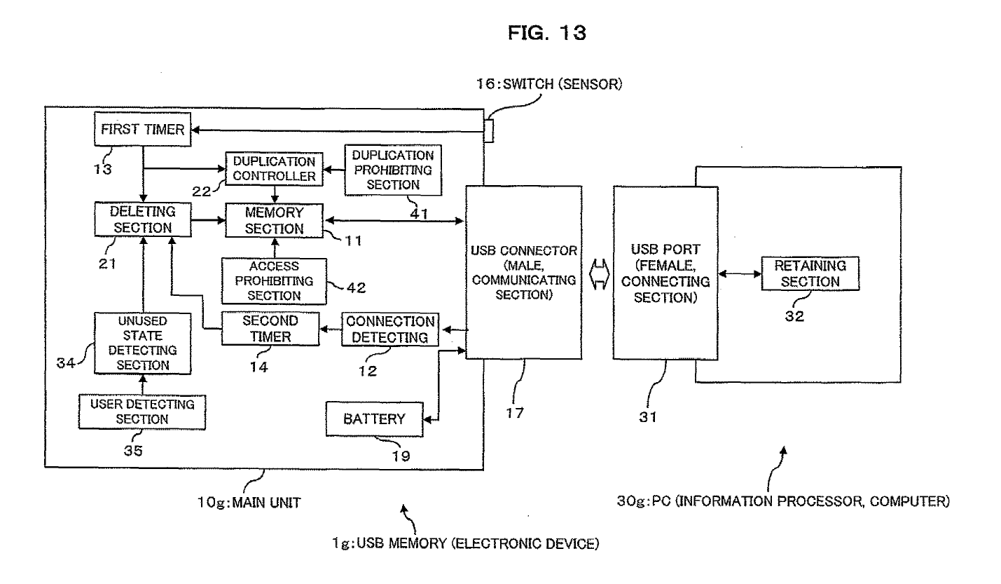

FIG. 13 is a diagram schematically showing the functional configurations of the USB (Universal Serial Bus) memory 1g and a PC (an information processor, a computer) 30g to which the USB memory 1g is connected.

Similarly to the USB memory 1a of the first embodiment, in the USB memory (an electronic device) 1g and the PC 30g of the fifth embodiment, inserting and connecting the USB connector 17 of the USB memory 1g into the USB port 31 of the PC 30g communicably connects the PC SOg to the USB memory 1g, so that the PC 30g reads, writes, and deletes data or performs other processes with respect to the memory section 11 of the USB memory 1g.

As shown in FIG. 13, the PC 30g of the fifth embodiment comprises a USE port (a USE connector (female), a connecting section) 31 and a retaining section 32.

The PC 30g has the hardware configuration identical to that of the PC 30a of the first embodiment shown in FIG. 3, so repetitious description is omitted here.

The Retaining section 32 retains various data pieces and specifically retains data stored in the memory section 11 under control of the duplication controller 22 that is to be detailed below. The Retaining section 32 takes the form of a memory device such as the HDD 305 and/or the RAM 303 shown in FIG. 3, for example.

As shown in FIG. 13, the main unit 10g of the USB memory 1g comprises a duplication controller 22, a duplication prohibiting section 41, an access prohibiting section 42, an unused state detecting section 34, and a user detecting section 35 in addition to the elements of the USB memory 1d of the second embodiment shown in FIG. 8.

The USB memory 1g is, as shown in FIG. 13, formed of the main unit 10g including a USB connector (a communicating section, a connection terminal) 17 and a memory section 11, and a cap 20g (the part, not shown) detachably attached to the USB connector 17 and the same in configuration as the cap 20a of the first embodiment.

Like reference numbers designating similar parts or elements throughout several views of different illustrated examples, so any repetitious description is omitted here.

The First timer 13 measures time passed for which a detached state of the cap has continued since the switch 16 has detected the detached state. Specifically, the first timer 13 detects the passage of a fifth time period (a first time period) predetermined since the detected state of the cap has been detected, and outputs a signal (a fifth time period detection signal) that notifies the passage to the duplication controller 22 to be detailed below.

Upon detection of passage of a sixth time period predetermined for which the cap has continued to be in the detached state, the first timer 13 outputs a signal (a sixth time period detecting signal) that notifies the passage to the deleting section 21.

The fifth time period is shorter than the sixth time period and therefore a backup of data in the memory section 11 can be made before the deleting section 21 deletes the data.

When the second timer 14 detects passage of a seventh time period (the fourth time period) predetermined since the connection detecting section 12 has detected the establishment of connection of the USB connector 17 to the PC 30g, the second timer 14 outputs a signal (a seventh time period detecting signal) that notifies the passage to the deleting section 21.

When the unused state detecting section 34 detects a transition of the PC 30g to any unused state on the basis of information from the user detecting section 35 and others, the unused state detecting section 34 outputs an unused state detecting signal to the deleting section 21.

The Duplication controller 22 controls to copy (make a backup of) of the data stored in the memory section 11 of the USB memory 1g into the retaining section 32 included in the PC 30g. If the duplication controller 22 receives a fifth time period detecting signal from the first timer 13, that is, if the first timer 13 detects passage of the fifth time period, the duplication controller 22 copies the data stored in the memory section 11 of the PC 30g into the retaining section 32, so that a backup of the data stored in the memory section 11 is made and stored into the retaining section 32.

In order to make a backup of the data stored in the memory section 11 of the USB memory 1g, the duplication controller 22 first notifies the PC 30g of the data capacity of the memory section 11 and queries the forwarding destination (i.e., the storing destination; the address) (for securing the forwarding destination and the memory capacity). In response to the query, the PC 30g sends (notifies) the information about the forwarding destination to the duplication controller 22, which, in turn, forwards and stores the data to and in the notified destination (retaining section 32).

If the HDD 305 in the PC 30g does not have an ample capacity to retain the backup data, the PC 30g responds to the USB memory 1g (to the duplication controller 22) with the indication of the absence of the forwarding destination. On this occasion, it is preferable for the PC 30g to display a message that the backup function is disabled on display 304.

Further, the memory section 11 of the USB memory 1g is capable of setting and storing an information (a backup forwarding completion flag) that notifies the completion of forwarding the backup of the data to the retaining section 32 in association with the information (e.g., the file name) that specifies the data. Upon completion of storing a backup of the data of the memory section 11 into the retaining section 32, the duplication controller 22 sets the backup forwarding completion flag to “1”.

This backup forwarding completion flags may be set one for each of the data pieces stored in the memory section 11, or may be set one for a number of data pieces stored in the memory section 11.

For example, the memory section 11 is capable of setting and storing the information (USB memory deletion completion flag), if the deleting section 21 deletes a data piece in the memory section 11, that notifies the deletion by the deleting section 21 in association with the information (e.g., the file name) that specifies the deleted data piece. The Deleting section 21 deletes a data pieces in the memory section 11, and then set the USB memory deletion completion flag to “1”.

The Duplication prohibiting section 41 prohibits the duplication controller 22 from copying data into the retaining section 32. For example, if the owner of the PC 30g is not a particular relative person having a particular relation to the USB memory 1g, the duplication prohibiting section 41 prohibits the duplication controller 22 from copying data into the retaining section 32.

A confirmation as to whether or not the owner of the PC 30g is not a particular relative person having a particular relation to the USB memory 1g is made by previously registering the fingerprint or an ID password to verify the PC 30g in the USB memory 1g; obtaining a fingerprint or an ID password for verification through the access to the PC 30g from the USB memory 1g; and collating the fingerprint or the ID password previously registered with the fingerprint or the ID password obtained.

If the user of the USB memory 1g is not the particular relative person with a particular relation into the USB memory 1g, the duplication prohibiting section 41 prohibits the duplication controller 22 from copying data to the retaining section 32.

A particular relative person with a particular relation to the USB memory 1g is a valid person to use the USB memory 1g, such as the user of the USB memory 1g, the owner of PC 30g or a person granted to use the USB memory 1g by the owner of the USB memory 1g.

A confirmation as to whether or not the user of the USB memory 1g is a particular relative person of the USB memory 1g can be carried out by various known methods. For example, as disclosed in the above Patent Reference 1, the fingerprint data of a particular relative person is previously stored in the memory section 11 of the USB memory 1g, and a fingerprint verification is performed, when the USB memory 1g is to be used, by collating the scanned fingerprint data with the registered fingerprint data previously registered.

The Deleting section 21 deletes the data stored in the memory section 11 upon receipt of a sixth time period detecting signal from the timer 13, that is upon detection of the passage of the sixth time period (the second time period), or upon receipt of a seventh time period detecting signal from the second timer 14, that is, upon detection of the passage of the seventh time period.

The Deleting section 21 deletes, if the data stored in the memory section 11 has been copied to the retaining section 32 of the PC 30g by the duplication controller 22, the data in the memory section 11. Specifically, if the backup forwarding completion flag in the memory section 11 is set to “1”, the deleting section 21 deletes a data piece for which backup forwarding completion flag in the memory section 11 is set to “1”.

If the deleting section 21 deletes a data piece stored in the memory section 11, the deleting section 21 sets the USB memory deletion completion flag for the deleted data piece in the memory section 11 to “1” upon completion of the deletion of the data piece.

The Deleting section 21 may delete the data stored in the memory section 11 only when the user of the PC 30g is the particular relative person having a particular relation to the PC 30g.

The Access prohibiting section 42 prohibits the PC 30g to access the memory section 11 specifically if the user of the PC 30g is not the particular relative person with a particular relation to the PC 30g.

In addition, the access prohibiting section 42 prohibits the PC 30g to access the memory section 11 if the user of the USB memory 1g is not the particular relative person with a particular relation to the USB memory 1g.

In the USB memory 1g of the fifth embodiment with the configuration described above, upon detachment of the cap from the USB connector 17 of the USB memory 1g, the cap detecting switch 109 detects the detachment (the detecting step), the main unit 10g of the USB memory 1g is turned on and each element in the main unit 10g is initialized.

Then the first timer 13 detects the time passage for which the cap has been in the detached state since the switch 16 has detected the detached state of the cap (the measuring step).

Upon establishment of connection of the USB memory 1g to the USB port 31 of the PC 30g, the USB interface 106 (connection detecting section 12) detects the establishment of connection (USB connection) of the main unit 10g to the USB port 31 of the PC 30g via the USB connector 17, and the second timer 14 measures (by countdown) the time passage for which the USB connector 17 has been connected to the PC 30a.

Upon detection of the passage of the fifth time period of the cap in the detached state, the first timer 13 outputs a fifth time period detecting signal to the duplication controller 22.

Upon receipt of the fifth time period detecting signal from the first timer 13, the duplication controller 22 controls to copy (make a backup of) the data stored in the memory section 11 of the USB memory 1g into the retaining section 32 included in the PC 30g.

Specifically, the duplication controller 22 notifies the PC 30g of data capacity of the memory section 11 and sends a query about the forwarding destination to the PC 30g. On the basis of the response from the PC 30g to the query, the duplication controller 22 forwards (copies) the data (the copying step). At that time, the duplication controller 22 retains the destination and the data amount (forwarding amount) of the backup data in association with the information (e.g., the file name) that specifies the forwarded data.

The PC 30g stores the data forwarded from the USB memory 1g in the retaining section 32 and sends a signal (a completion report) that notifies the completion of the forwarding to the USB memory 1g in the meanwhile the duplication controller 22 sets the backup forwarding completion flag to “1”.

After that, the deleting section 21 deletes the forwarded data stored in the memory section 11 (the deleting step) and sets the USE memory deletion completion flag to “1”.

Upon detection of an expiration of the sixth time period predetermined for which the cap has been in a detached state, the first timer 13 outputs a sixth time period detection signal to the deleting section 21. Upon detection of passage of the seventh time period predetermined since connection establishment of the USB connector 17 to the PC 30a, the second timer 14 also outputs a seventh time period detecting signal to the deleting section 21.

Further, upon detection of a transition to any unused state of the PC 30g on the basis of information from user detecting section 35 or the like, the unused state detecting section 34 outputs an unused state detecting signal to the deleting section 21.

Upon receipt of the sixth time period detecting signal, the seventh time period detecting signal, or the unused state detecting signal, the deleting section 21 deletes data stored in the memory section 11.

The PC 30g can confirm whether or not making a backup of a data piece is completed with reference to the backup forwarding completion flag set for the data piece, and can confirm whether or not deletion of a data piece from USB memory 1g is completed with reference to the USB memory deletion completion flag set for the data piece.

In copying the data stored in the memory section of the USB memory 1g into the retaining section 32 of the PC 30g, if, for example, the PC 30g is judged not to be related to a particular relative person with a particular relation to the USB memory 1g or the user of the USB memory 1g is judged not to be the particular relative person with a particular relation to the USB memory 1g, the duplication prohibiting section 41 prohibits the duplication controller 22 from copying the data to the retaining section 32.

Further, the access prohibiting section 42 prohibits the PC 30g from accessing the memory section 11 if the user of the PC 30g is judged not to be the particular relative person with a particular relation to the PC 30g.

When the backup data in the retaining section 32 copied by the duplication controller 22 is to be restored back into the USB memory 1g, the operator inputs a restoring instruction into the PC 30g via the keyboard 306 or the mouse 307.

If such a restoring instruction is input, the USB memory 1g obtains the forwarding destination and the capacity of the data from the memory section 11; obtains the data to be restored on the basis of these information pieces; and forwarding the backup data to the USB memory 1g (memory section 11), so that the backup data can be restored. Completion of such restoring sets both the backup forwarding completion flag and the USB memory deletion completion flag to “0”.

As described above, the USB memory 1g and the PC 30g according to the fifth embodiment of the present invention can guarantee the same effects as the second embodiment and additionally avoid a loss of data stored in the USB memory 1g because the duplication controller 22 copies the data into the retaining section 32 of the PC 30g (makes a backup of data and stores the backup data in the retaining section 32).

If, for example, the PC 30g is judged not to be related to a particular relative person with a particular relation to the USB memory 1g or the user of the USB memory 1g is judged not to be the particular relative person with a particular relation to the USB memory 1g, the duplication prohibiting section 41 prohibits the duplication controller 22 from coping the data to the retaining section 32. With this configuration, even when a third person invalidly uses the USB memory 1g and/or the PC 30g, the data stored in the memory section 11 of the USB memory 1g is not copied into the PC 30g. Thereby, it is possible to avoid illegal use of the data stored in the USB memory 1g by a third person and to improve confidentiality of the data stored in the USB memory 1g.

Further, since the access prohibiting section 42 prohibits the PC 30g from accessing the memory section 11 if the user of the PC 30g is judged not to be the particular relative person with a particular relation to the PC 30g, that also makes it possible to avoid illegal use of the USB memory 1g by a third person and to improve confidentiality of the data stored in the USB memory 1g.

### (H) Sixth Embodiment

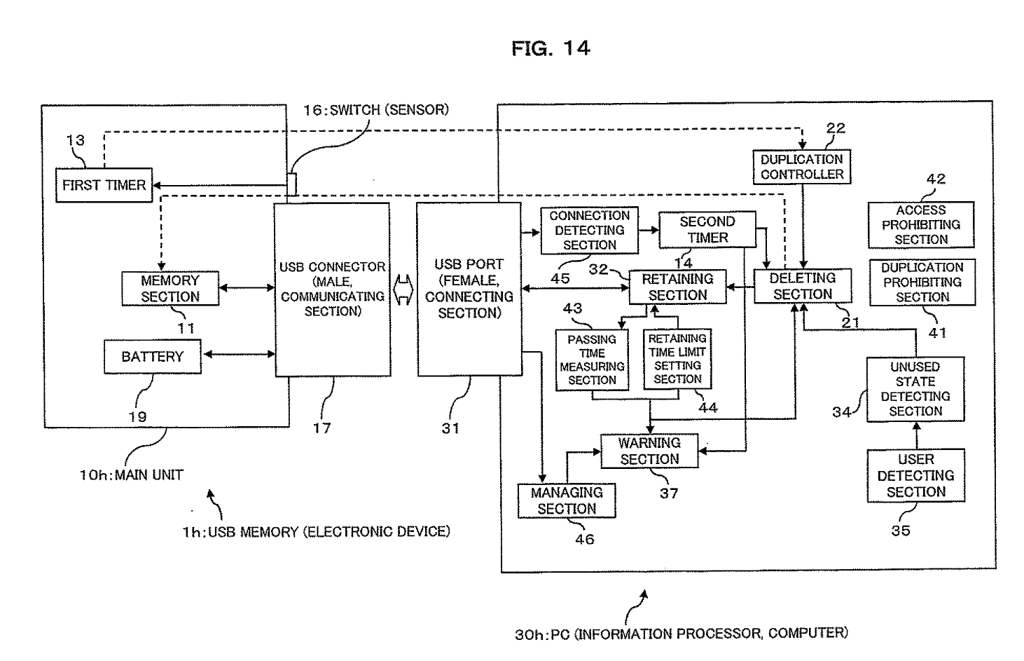

FIG. 14 is a diagram schematically showing functional configurations of the USB (Universal Serial Bus) memory 1h and a PC (an information processor, a computer) 30h according to a sixth embodiment of the present invention.

Similarly to the USB memory 1a of the first embodiment, in the USB memory (an electronic device) 1h and the PC 30h of the sixth embodiment, inserting and connecting the USB connector (a communicating section, a connection terminal) 17 of the USB memory 1h into the USB port 31 of the PC 30h communicably connects the USB memory 1h to the PC 30h, so that the PC 30a reads, writes, and deletes data or performs other processes in the memory section 11 of the USB memory 1h.

As shown in FIG. 14, the PC 30h of the sixth embodiment comprises a duplication controller 22, a duplication prohibiting section 41, a deleting section 21, an access prohibiting section 42, a second timer 14, a connection detecting section 12, an unused state detecting section 34, and a user detecting section 35, which are included in the main unit 10g of the USB memory 1g of the fifth embodiment shown in FIG. 13, and additionally comprises a passing time measuring section 43, a retaining time limit setting section 44, a warning section 37, and a managing section 46.

The USB memory 10g (sic) comprises a cap (part, not shown) detachably attached to the USB connector 17 similarly in configuration to the cap 20a of the USB memory 1a of the first embodiment.

Like reference numbers designating similar parts or elements throughout several views of different illustrated examples, so any repetitious description is omitted here.

The PC 30g (sic) of the sixth embodiment has the hardware configuration the same as the PC 30a of the first embodiment shown in FIG. 3, so any repetitious description is omitted here.

The Passing time measuring section 43 obtains the time passed since the last access to the data stored in the memory section 11 or the retaining section 32 has been made specifically by managing the time and the date when an access to the data has been made and measuring the time passed from the access with a timer (not shown) or obtaining the time passed based on the difference from the current time.

The Retaining time limit setting section 44 sets a time limit to retain the data stored in the memory section 11 or the retaining section.

Here, a specific manner to set the time limit to retain the data is exemplified by preparing a management table to manage the information (retaining time limit information) about a retaining time limit in a dedicated region provided in the USB memory 1h or by embedding the retaining time limit information in a standard file attribute data region of an OS (Operating System) such as Windows (trademark).

On the basis of the retaining time limit set for each data pieces, a data piece having the retaining time limit which expires first is extracted and the retaining time limit of the data piece is set in a timer (not shown).

Upon notification of the expiration of the retaining time limit from the timer, the data piece is deleted and the retaining time limit of a data piece which expires next is set in the timer. If two or more data pieces expire at the same time, these retaining time limits may be set so as to shift from one another.

A retaining time limit is set into the timer by a command dedicated to the USB memory 1h, by appropriating the data writing into a dedicated region, or others.

In order to realize the above manner, it is preferable that a software that manages a retaining time limit is installed into the PC 30h and a management firmware is installed also into the USB memory 1h.

Upon detection of the passage of an eighth time period (the second time period) predetermined since the connection detecting section 12 has detected establishment of connection of the USB connector 17 to the PC 30h, the second timer 14 outputs a signal (an eight time period detecting signal) that notifies the expiration to the warning section 37. Further, upon detection of an expiration of a ninth time period (the first time period) predetermined since the connection detecting section 12 has detected establishment of connection of the USB connector 17 to the PC 30h, the second timer 14 outputs a signal (a ninth time period detecting signal) that notifies the expiration to deleting section 21.

The Warning section 37 issues a warning if the memory section 11 or the retaining section 32 retains the data having a passing time obtained by the passing time measuring section 43 is longer than the retaining time limit set by the retaining time limit setting section 44 (expired data).

The Warning section 37 further issues a warning upon receipt of the eighth time period detection signal from the second timer 14.

Upon detection of an expiration of a sixth time period (the second time period) predetermined for which the cap has continued to be in the detached state by the first timer 13, the warning section 37 issues a warning similarly to the USB memory 1e of the third embodiment.

Alternatively, the warning section 37 may issue a warning if the first timer 13 detects that an expiration of time user had detached the cap from the USB connector 17 is longer than a predetermined time period.

In the PC 30h of the sixth embodiment, the deleting section 21 deletes the data stored in the memory section 11 or the retaining section 32, if the data has the passing time obtained by the passing time measuring section 43 the ninth time period longer (the first time period) or more than the retaining time limit set by the retaining time limit setting section 44.

A retaining time limit and a predetermined time period for deletion by the deleting section 21 can be arbitrarily determined by the user via the keyboard 306 or others.

The Managing section 46 registers an information to specify the USB memory 1h in advance and managing the information, and specifically registers the information (specification information or the like) to specify USB memory 1h to be granted to access PC 30h.

In detail, the USB memory 1h is registered previously and the managing section 46 assigns a management number and a management ID (Identification) to the USB memory 1h granted to connect to the PC 30h, and manages the assigned number and ID in a management table and the like.

The Warning section 37 then issues a warning with reference to the management table if the USB memory 1h which is not managed by the managing section 46 is connected to the USE port 31.

In the PC 30h of the sixth embodiment with the configuration described above, establishment of connection of the USE memory 1h to the USB port 31 prompts the PC 30h to retrieve the presence or the absence of the management information such as an above retaining time limit or a time period to delete for the data stored in the memory section 11.

Here, the presence of data for which a retaining time limit or a predetermined time period for deletion is set prompts the passing time measuring section 43 or the like to judge whether the retaining time limit does not expire and if the data expires, the warning section 37 warns the user.

Further, the presence of the data having the passing time obtained by the passing time measuring section 43 a predetermined time period (the ninth time period) longer or more than the retaining time limit causes the deleting section 21, which in response deletes the data.

Further, connection of the USB memory 1h to the USB port 31 prompts the PC 30h to obtain specification information of the USB memory 1h through the USB connector 17 and the USB port 31 and refer to the managing section 46. If the USB memory 1h being connected to the USB port 31 is not managed by the managing section 46, the warning section 37 issues a warning.

An alternative to the warning by the warning section 37, an access to the HDD 305 of the PC 30h may be prohibited and/or the USB memory inserted is disabled.

Even if the USB memory 1h being connected to the USB port 31 is managed by the managing section 46, the PC 30h causes the second timer 14 to measure the time that has passed since the USB memory 1h was connected to the USE port 31. If the second timer 14 detects the passage of the eighth time period, the warning section 37 issues a warning to prevent the USB memory 1h from being left inserted in the USB port 31 of the PC 30h.

As described above, the USB memory 1h and the PC 30h of the sixth embodiment guarantees the same effects as the foregoing fifth embodiment, and, if there is an expired data pieces among the data pieces for which retaining time limits are set, the expired data piece is deleted so that the data pieces can be prevented from being divulged, which improves data confidentiality.

The presence of an expired data piece issues a warning that notifies the operator of the presence of the expired data piece so that the operator copes with the data by the optimum countermeasure such as deletion. It is therefore possible to improve the data confidentiality and enhance the convenience.

Connection of a USB memory 1h which is not registered (unregistered) to the USB port 31 causes the warning section 37 to issue a warning, so that, for example, it is possible to prevent the data stored in the PC 30h from being invalidly copied to such an unregistered USB memory 1h by a third person, improving confidentiality of the data stored in PC 30h.

### (I) Others

The CPU (Central Processing Unit) of the information processor (PC30a, 30e, 30g, and 30h) can execute a management program functions as the duplication controller 22, access prohibiting section 42, duplication prohibiting section 41, deleting section 21, passing time measuring section 43, retaining time limit setting section 44, managing section 46, unused state detecting section 34, user detecting section 35, user confirming section 38, USB memory confirming section 40, and warning controller 33.

The management program to realize the functions of the duplication controller 22, access prohibiting section 42, duplication prohibiting section 41, deleting section 21, passing time measuring section 43, retaining time limit setting section 44, managing section 46, unused state detecting section 34, user detecting section 35, user confirming section 38, USB memory confirming section 40, and warning controller 33 is provided in the form of being recorded in a computer-readable recording media such as a flexible disc, a CD-ROM (e.g., CD-ROM, CD-R, CD-RW), a DVD (e.g., DVD-ROM, DVD-RAM, DVD-R, DVD+R, DVD-RW, DVD+RW), a magnetic disc, an optical disk, and/or a magneto-optical disk. The computer reads the program from such a recording medium to transfer the program to an internal or external storage device, to store the programs therein. Alternatively, the programs can be recorded in storage devices (recording media) such as magnetic discs, optical discs, and magneto-optical discs, and can be transferred to the computer over a communication network.

The functions of the duplication controller 22, access prohibiting section 42, duplication prohibiting section 41, deleting section 21, passing time measuring section 43, retaining time limit setting section 44, managing section 46, unused state detecting section 34, user detecting section 35, user confirming section 38, USB memory confirming section 40, and warning controller 33 are realized by the microprocessor (CPU 301 in the present embodiments) executing a set of programs stored in an internal storage unit (e.g., RAM 303 or ROM 302). At that time, the computer may read the program stored in the recording medium and execute the read program.

In the present embodiments, the “computer” is defined as a concept including hardware and an OS (Operating System), and hardware operating under control of an OS. Further, in cases where hardware is capable of operating by itself without the necessity of an OS, the hardware is equivalent to the “computer.” The hardware includes at least a microprocessor such as a CPU and a means for reading computer programs from recording media. In the present embodiments, PC 30a, 30e, 30g, and 30h have the function as a computer.

Moreover, as recording media used in the embodiments of the present invention, not only the above-mentioned flexible discs, CDs, DVDs, magnetic discs, optical discs, and magneto-optical discs, but also various types of other computer-readable media, such as IC cards, ROM cartridges, magnetic tapes, punch cards, internal storage devices (memories such as RAMs and ROMs), external storage devices, and printed matter with any codes such as barcodes printed thereon, are also applicable.

Further, the processor 102 executing a USB memory management program included in the internal storage devices (e.g., RAM 103 and controlling soft ROM 104) in the USB memories 1a-1g functions as the duplication controller 22, access prohibiting section 42, duplication prohibiting section 41, deleting section 21, passing time measuring section 43, retaining time limit setting section 44, managing section 46, unused state detecting section 34, user detecting section 35, user confirming section 38, USB memory confirming section 40, and warning controller 33 described above.

The present invention should by no means be limited to the above embodiments, but various changes or modifications may be suggested without departing from the gist of the invention.

For example, in the foregoing first, third to fifth embodiments and the modifications thereof, warning section 15 takes the form of buzzer circuit 108, so that issue of alarm sound having a particular frequency acts on the sense of hearing of the user. The warning, however, is not limited to this. Alternatively, the warning may acts on the five senses (vision, touch, taste, and scent) other than hearing, such as vibration generated by a vibration generating circuit or lighting a lamp.

Further, the USB memory 1d of the second embodiment may comprise the warning section 15 of the first embodiment 1a to warn the user before the deleting section 21 is to delete data stored in the memory section 11 in response to a detection of the first time period by the first timer 13 or to a detection of the second time period by the second timer 14. That notifies the user of forthcoming deletion of the data stored in the memory section 11, and is therefore convenient.

The USB memory 1d of the second embodiment may comprise a warning section 15 and a battery remaining amount measuring section 18 of the first embodiment 1a to warn the user when battery remaining amount measuring section 18 detects the remaining amount of a battery 19 comes to be a predetermined amount or lower. That makes it possible for the user to recognize low battery states and is therefore convenient.

Additionally, in the USB memory 1g and 1h of the fifth and sixth embodiments, if the unused state detecting section 34 detects a transition of the PC 30g or 30h to an unused state, the duplication controller 22 may copy the data stored in the memory section 11 into the retaining section 32 of the PC 30g or 30h or a backup of data stored in the memory section 11 may be made and stored in the retaining section 32 of the PC 30g or 30h and the data may be deleted from the memory section 11.

Here, the unused state detecting section 34 may detect a transition of the PC 30g or 30h to an unused state when detecting a shutting down the power of the PC 30g or 30h, or when detecting a transition of the PC 30g or 30h to a power saving mode.

The foregoing embodiments and modifications assume that the electronic device is a USB memory, but is not limited to this. Alternatively, the electronic device may conform to other communication protocol and/or bus standard such as IEEE 1394 (FireWire) standard, which is powered by bus power similarly to the USB standard.

The foregoing embodiments and modifications assume that the part is the cap of the USB memory, but is not limited to this. Alternatively, the part may be a case which accommodates a USB memory, other mobile storage device, or an electronic device other than a memory.

The foregoing embodiments and modifications assume that the communicating section of the electronic device is electrically connected to the information processor but is not limited to this. Alternatively, the communicating section may be capable of wirelessly connecting the electronic device to the information processor. For this purpose, it is sufficient that the connecting section of the information processor is configured to be wirelessly communicable.

In the foregoing embodiments and the modifications thereof, each of the first to the seventh time period may at least be partially determined arbitrarily by the user.

Further, the PC 30h of the above sixth embodiment may comprise the passing time measuring section 43, and the retaining time limit setting section 44, but is not limited to this. Alternatively, the passing time measuring section 43, and the retaining time limit setting section 44 may be included in the USB memory 1a, 1b, 1c, 1d, 1e, 1f, and 1g, and the PC 30a, 30e, 30g, and 30h of other embodiments and modifications.

The USB memory 1d of the second embodiment, the USB memory 1g of the fifth embodiment, and the USB memory 1h of the sixth embodiment may comprise a battery remaining amount measuring section 18 in the battery 19, and the warning section 15 may issue a warning in response to detection the remaining amount of the battery 19 detected to be a predetermined amount or less.

With reference to the disclosure of the embodiments of the present invention, those skilled in the art carry out and produce the present invention.

### INDUSTRIAL APPLICABILITY

The present invention can be applied to management of various electronic devices such as USB or IEE 1394, which are communicably connected to an information processor and which conform to various standards.

What is claimed is:

1. An electronic device including a communicating section communicably connects said electronic device to an information processor, said electronic device comprising:
a main unit detachably coupled to a part and including said communicating section;
a sensor detecting the state of said part being detached or not;
a first timer measuring elapsed time since the detection of detachment; and
a warning section warning the user of said electronic device,
said warning section warning the user if said first timer detects the passage of a first time period.

2. An electronic device according to claim 1, further comprising:
a connection detecting section detecting establishment connection of said main unit to the information processor via said communicating section; and
a second timer measuring elapsed time since the detection of detachment establishment of the connection,
said warning section warning the user if said second timer detects expiration of a second time period.

3. An electronic device according to claim 1, further comprising:
a chargeable battery supplying electricity to said warning section; and
a battery remaining amount measuring section measuring the remaining amount of said chargeable battery,
said warning section warning the user if said battery remaining amount measuring unit detects that the remaining amount of said chargeable battery is less than a predetermined amount.

4. An electronic device according to claim 3, wherein said chargeable battery is incorporated in said main unit and is charged with electricity supplied from the information processor via said communicating section while said communicating section connects said main unit to the information processor.

5. An electronic device according to claim 3, wherein said chargeable battery is incorporated in said part and is charged with electricity supplied from said main unit.

6. An electronic device according to claim 5, wherein:
said chargeable battery is further incorporated in said main unit;
said second chargeable battery incorporated in said main unit is electrically connected to said first chargeable battery incorporated in said parts while said part is attached to said main unit; and
said first battery incorporated in said part is charged with electricity supplied by said second battery incorporated in said main unit while said part is attached to said main unit.

7. An electronic device according to claim 1, further comprising a memory being able to retain data.

8. An electronic device according to claim 1, wherein said part is in the form of a cap detachably attached to said communicating section.

9. An electronic device according to claim 1, wherein said communicating section is in the form of a connection terminal electrically connected to the information processor.

10. An electronic device according to claim 1, being a portable memory device.

11. An electronic device according to claim 1, being a USB (Universal Serial Bus) device connected to the information terminal via a USB.

12. A management method preventing an electronic device comprising a communicating section communicably connecting the electronic device to an information processor from being left, comprising the steps of:
(a) detecting detached state of a part configured to be detachably attached to a main unit of the electronic device;
(b) measuring elapsed time since the detection of detachment in said step (a) of detecting; and
(c) warning, if said step (b) of measuring detects the expiration of a first time period.

13. A method for managing according to claim 12, further comprising the steps of:
(d) measuring elapsed time since a communicating section provided in the electronic device to which the part is detachably attached has been connected to the information processor; and
(e) warning if said step (d) detects expiration of a second time period.

14. A computer-readable recording medium which stores a management program for preventing an electronic device comprising a communicating section communicably connecting the electronic device to an information processor from being left, wherein said program instructs the electronic device to execute the following steps of:
(a) detecting a detached state of a part configured to be detachably attached to a main unit of the electronic device;
(b) measuring elapsed time since the detection of detachment in said step (a) of detecting; and
(c) warning, if said step (b) of measuring detects the expiration of a first time period.

15. A computer-readable recording medium which stores a management program according claim 14, further instructing the electronic device to execute the following steps of:
(d) measuring elapsed time since a communicating section provided in the electronic device to which the part is detachably attached has been connected to the information processor; and
(e) warning if said step (d) measures the passage of a second time period.
